(19) United States
(12) Patent Application Publication
(10) Pub. No.: US 2008/0182171 A1
(43) Pub. Date: Jul. 31, 2008

(54) Composition for negative electrode of non-aqueous rechargeable battery and non-aqueous rechargeable battery prepared by using same

(76) Inventors: Hideaki Maeda, Yokohama-shi (JP); Masaki Koike, Yokohama-shi (JP); Yasuaki Hiramura, Yokohama-shi (JP); Susumu Hiyama, Fujisawa-shi (JP); Sabro Shinkai, Fujisawa-shi (JP); Manabu Katsumi, Fujisawa-shi (JP); Sung-Soo Kim, Suwon-si (KR)

Correspondence Address: ROBERT E. BUSHNELL, 1522 K STREET NW, SUITE 300, WASHINGTON, DC, 20005-1202, US

(21) Appl. No.: 12/000,906

(22) Filed: Dec. 18, 2007

(30) Foreign Application Priority Data
Dec. 18, 2006 (JP) 2006-339508
Nov. 26, 2007 (KR) 10-2007-0120974

(51) Int. Cl. H01M 4/40

(52) U.S. Cl. 429/231.5

(57) ABSTRACT

The present invention relates to a negative material for a non-aqueous rechargeable battery and a non-aqueous rechargeable battery including the same. The negative material for a non-aqueous rechargeable battery includes lithium vanadium oxide that is obtained by mixing a lithium compound such as lithium carbonate (Li₂CO₃) and a vanadium compound such as vanadium pentaoxide (V₂O₅) with an organic acid such as oxalic acid ((COOH₂) to obtain an organic acid salt precursor and firing the organic acid salt precursor. The negative material for a non-aqueous rechargeable battery can improve charge and discharge characteristics of a non-aqueous rechargeable battery due to uniform composition.

### CLAIM OF PRIORITY

This application makes reference to, incorporates the same herein, and claims all benefits accruing under 35 U.S.C. §119 from applications earlier filed in the Japan Patent Office on 18 Dec. 2006 and there duly assigned Serial No. 2006-339508, and in the Korean Intellectual Property Office on 26 Nov. 2007 and there duly assigned Serial No. 10-2007-0120974.

### BACKGROUND OF THE INVENTION

1. Field of the Invention

The present invention relates to a negative material for a non-aqueous rechargeable battery such as a lithium ion rechargeable battery and a non-aqueous rechargeable battery including the same. More particularly, the present invention relates to a negative material for a non-aqueous rechargeable battery being able to improve the charge and discharge characteristics of a non-aqueous rechargeable battery due to uniform composition of the negative material, and to a non-aqueous rechargeable battery including the improved negative material.

2. Description of the Related Art

Contemporary rechargeable lithium batteries include a positive electrode and a negative electrode that are capable of intercalating and deintercalating lithium ions respectively, impregnated in a non-aqueous electrolyte (see claims 3-11 and FIG. 10 disclosed in Japanese Patent laid-open No. 2003-68305 to Koji Yamamoto et al., entitled Negative Material for Secondary Lithium Battery and its Manufacturing Method, published on 7 Mar. 2003). The negative active material includes lithium vanadium oxide. The lithium vanadium oxide is prepared by mixing a lithium source, such as lithium hydroxide and the like, and a vanadium source, such as vanadium trioxide and the like, in a solid-phase method, and firing the mixture at not lower than 650° C. or higher.

When a non-aqueous rechargeable battery is charged, and its negative electrode is electrified to be negative, lithium ions intercalated into the positive electrode are deintercalated and then intercalated into the negative electrode. In addition, when a non-aqueous rechargeable battery is discharged, lithium ions intercalated into the negative electrode are deintercalated and then intercalated into the positive electrode.

The test cell including an electrode of metallic lithium and a counter electrode of a lithium vanadium oxide sample may be prepared according to contemporary practice with a solid-phase method was measured for the lithium standard open current potential by drying and mixing lithium hydroxide and vanadium trioxide, then firing it under a nitrogen atmosphere at 1100° C.

When the lithium vanadium oxide is prepared with a drying method however, the composition of the subject material is not uniform and it is hard to maintain a stable crystalline structure. Consequently, the potential is not stabilized after repeated the charge and discharge cycles, so that the charge and discharge characteristics deteriorate after several repetitions of charge and discharge cycles.

### SUMMARY OF THE INVENTION

It is therefore, one object of the present invention to provide an improved non-aqueous rechargeable battery.

It is another object to provide an improved negative material for a non-aqueous rechargeable battery.

It is still another object to provide a negative material exhibiting an uniform composition and a non-aqueous rechargeable battery using a negative material exhibiting an uniform composition.

It is yet another object to provide a negative material having a stabilized potential over successive cycles of charge and discharge, and a non-aqueous rechargeable battery using a negative material exhibiting a stabilized potential over successive cycles of charge and discharge.

One embodiment of the present invention provides a negative material for a non-aqueous rechargeable battery that is capable of improving charge and discharge characteristics of a non-aqueous rechargeable battery, and a non-aqueous rechargeable battery including the same.

An embodiment of the present invention may be constructed with a negative material for a non-aqueous rechargeable battery including lithium vanadium oxide, wherein the open circuit potential has a plateau with a potential that is varied within 0.05V over 25% or more based on the entire reaction period when the lithium ions are intercalated and deintercalated, and the plateau has an average potential of intercalation of lithium ions ranging from between 0.20 to 0.25 V and an average potential of deintercalation of lithium ions ranging from between 0.23 to 0.27 V.

The negative material for a non-aqueous rechargeable battery has a uniform composition, so it can improve the charge and discharge characteristics of a non-aqueous rechargeable battery.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a two coordinate graph illustrating a relationship between the capacity and potential of a negative material for a contemporary, non-aqueous rechargeable battery.

FIG. 2 is a vertical cross-sectional elevation view of a non-aqueous rechargeable battery constructed as one embodiment of the principles of the present invention.

FIG. 3 is a two coordinate graph showing an X-ray diffraction analysis result of lithium vanadium oxides according to Example 1 and Comparative Example 1.

FIG. 4 is a two coordinate graph illustrating a partially enlarged view of a peak for the (003) plane shown in FIG. 3 for Example 1 and Comparative Example 1.

FIG. 5 is a two coordinate graph illustrating a relationship between discharge capacity of the negative material for a non-aqueous rechargeable battery as a function of the ratio of lithium and vanadium used during formation of an organic acid salt.

FIG. 6 shows a relationship between an amount of an organic acid used during formation of an organic acid salt, and discharge capacity of the negative material for a non-aqueous rechargeable battery.

FIG. 7 shows a relationship between capacity and potential in mAh/g of the negative material for a non-aqueous rechargeable battery according to Example 1.

### DETAILED DESCRIPTION OF THE INVENTION

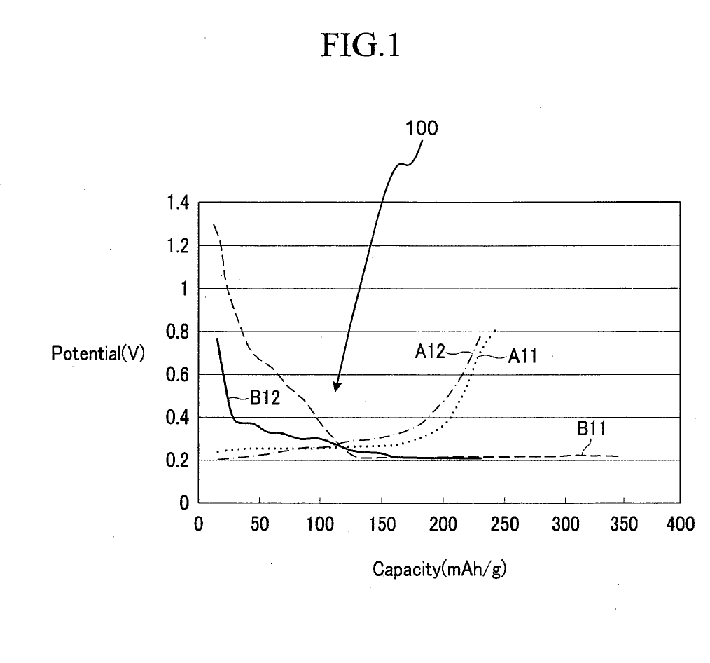

Turning now to the drawings, FIG. 1 shows charge and discharge characteristics of a contemporary lithium vanadium oxide negative material. As earlier explained herein, when a non-aqueous rechargeable battery is charged, and its negative electrode is electrified to be negative, lithium ions intercalated into the positive electrode are deintercalated from the positive electrode and those deintercalated lithium ions are then intercalated into the negative electrode. In addition, when a non-aqueous rechargeable battery is discharged, lithium ions intercalated into the negative electrode are deintercalated from the negative electrode and those deintercalated lithium ions are then intercalated into the positive electrode.

A test cell including an electrode of metallic lithium and a counter electrode of the conventional lithium vanadium oxide sample prepared by a solid-phase method was measured for the lithium standard open current potential. The vertical axis refers to the voltage potential (unit: Volts), and the horizontal axis refers to capacity (unit: mAh/g). The sample is obtained by drying and mixing lithium hydroxide and vanadium trioxide, then firing the mixture of lithium hydroxide and vanadium trioxide under a nitrogen atmosphere at 1100° C.

In FIG. 1, A11 refers to the first intercalation of lithium ions when the negative electrode is electrified to become negative and lithium ions are intercalated into the negative electrode while the non-aqueous rechargeable battery is being charged, and B11 refers to the first deintercalation of lithium ions from the negative electrode when the non-aqueous rechargeable battery is discharged. A12 refers to the 10th intercalation of lithium ions when the negative electrode is electrified to become negative and the lithium ions are intercalated into the negative electrode, and B12 refers to the 10th deintercalation of lithium ions from the negative electrode.

As shown in FIG. 1, a plateau 100 in which the potential varies within 0.05V when lithium ions are firstly intercalated (A11) into the negative electrode and first deintercalated (B11) from the negative electrode, is formed over less than 25% of the abscissa based on the entire reaction period illustrated, where the abscissa is defined as the horizontal axis. That is, the flat potential is shown when lithium ions are intercalated into and deintercalated from the negative electrode material during the first cycle. On the other hand, the plateau is not shown during the 10th intercalation (A12) of lithium ions and 10th deintercalation (B12) of lithium ions, which shows that the charge and discharge characteristics are not preferable.

When the lithium vanadium oxide is prepared by a drying method, the composition of the subject material is not uniform and it is therefore hard to maintain a stable crystalline structure. Then, because the potential is not stabilized after repeating the charge and discharge, so the charge and discharge characteristics deteriorate.

Turning now to the principles of the present invention, a negative material for a non-aqueous rechargeable battery constructed as one embodiment, may be prepared with lithium vanadium oxide by firing an organic acid salt including lithium and vanadium.

The negative material for a non-aqueous rechargeable battery includes lithium vanadium oxide including LiₐV_{b}M_{c}O_{d} that is obtained by firing an organic acid salt precursor, LiₐV_{b}M_{c}O_{d}(C₂O₄). The M is an arbitrary element, and, a, b, c, and d are arbitrary values.

The organic acid salt is obtained by mixing a lithium compound and a vanadium compound with an organic acid. According to one embodiment, the organic acid salt such as LiₐV_{b}M_{c}O_{d}C₂O₄ is prepared by mixing a lithium compound such as Li₂CO₃ together with a vanadium compound such as V₂O₅ with an organic acid such as (COOH)₂.

The negative material obtained from the above method has a peak intensity ratio of the (104) plane to the (003) plane ranging from between 0.2 to 0.8. According to another embodiment, the peak intensity ratio of the (104) plane to the (003) plane ranges from 0.3 to 0.6. When the peak intensity ratio is less than 0.2 however, the obtained crystal phase has problems because a layered basal plane is mainly developed and a prismatic plane is less developed.

According to one embodiment, the negative material for a non-aqueous rechargeable battery, has a molar ratio of lithium and vanadium in the lithium compound and the vanadium compound that are mixed with an organic acid salt that ranges from between 1.2:1 to 1.24:1.

Furthermore, according to one embodiment, the organic acid is present at a molar weight of between 1.5 to 5 times more than the molar weight required for reacting with the lithium compound and the vanadium compound.

According to the embodiment, the organic acid salt is obtained from the chemical reaction represented in the following Reaction Scheme 1. The amount of organic acid used in the reaction refers to X-Y moles, and the amount of organic acid present in the reaction refers to X moles. Furthermore, z is an arbitrary value.

### Reaction Scheme 1

0.22Li₂CO₃+V₂O₅+X(COOH)₂+zM→LiₐV_{b}M_{c}O_{d}C₂O₄+Y(COOH)₂ (1)

According to the negative material for a non-aqueous rechargeable battery of one embodiment, the lithium vanadium oxide forms a plateau in which the potential varies within a range of 0.05V when the lithium ions are intercalated (A11) and deintercalated (B11) during the first cycle over 25% or more based of the cycle as illustrated along the abscissa, over the entire reaction period (horizontal axis).

A plateau has an average potential for intercalating lithium ions ranging from between 0.20 to 0.25 Volts, and an average potential for deintercalating lithium ions ranging from between 0.23 to 0.27 Volts.

According to the embodiment, the charge and discharge characteristics are determined with a test cell including an electrode of a negative material including lithium vanadium oxide and a counter electrode including metallic lithium. The test cell shows a flat potential in which the open circuit potential ranges from 0.20 to 0.25V when lithium ions are intercalated. Further, the flat potential ranges have an open circuit potential ranging from 0.23 to 0.27V when lithium ions are deintercalated. The flat potential has a plateau in which the potential is varied within 0.05V over 25% or more based on the entire reaction period of intercalation and deintercalation of lithium ions.

In the negative material for a non-aqueous rechargeable battery constructed as one embodiment, the charge and discharge characteristics after the first intercalation and deintercalation of lithium ions have a plateau over 25% or more along the abscissa based on the entire reaction period. According to this embodiment, in the charge and discharge characteristics after the second cycle, the plateau the potential varies within 0.05V over 25% or more based on the entire reaction period is shown when the lithium ions are intercalated and deintercalated. Furthermore, after the capacity has deteriorated by almost the entirety of the life-cycle, the plateau may be shown over less than 25% of the reaction cycle displayed along the abscissa, based on the entire reaction period.

According to another embodiment, in the negative material for a non-aqueous rechargeable battery for that embodiment, the charge and discharge characteristics after the first intercalation and deintercalation of lithium ions has a plateau that extends over 40% or more of the reaction cycle illustrated along the abscissa, based on the entire reaction period. According to this embodiment, the charge and discharge characteristics have a plateau in which the potential varies within 0.05V over 40% or more along the abscissa, based on the entire reaction period when the lithium ions are intercalated and deintercalated for two or more cycles. Furthermore, after the capacity has deteriorated over the designated cycle-life of that battery, the plateau may decrease to a value of somewhat less than 40% based on the entire reaction period illustrated along the abscissa.

According to a negative material for a non-aqueous rechargeable battery including lithium vanadium oxide for another embodiment, the charge and discharge characteristics have a plateau in which the potential is varies within a maximum of 0.05V over 25% or more alone the abscissa, based on the entire reaction period of the intercalation or deintercalation of lithium ions illustrated, and the plateau has an average potential of intercalation of lithium ions of between 0.20 and 0.25V and an average potential of deintercalation of lithium ions of between 0.23 and 0.27V, while the charge and discharge characteristics after the first intercalation and deintercalation have a plateau over 25% or more based along the abscissa, over the entire reaction period.

According to another embodiment, the non-aqueous rechargeable battery includes a negative electrode including the negative material for a non-aqueous rechargeable battery, a positive electrode, and an electrolyte.

According to one embodiment, a lithium vanadium oxide for a non-aqueous rechargeable battery is obtained by firing an organic acid salt including lithium and vanadium to provide a uniform composition and a stable structure. Thereby, the charge and discharge potential is more stable, and consequently, the charge and discharge characteristics are improved. The source of vanadium may include inexpensive V₂O₅ including 5 valent vanadium. Thereby, it is possible to reduce the cost for producing a negative material for a non-aqueous rechargeable battery and a non-aqueous rechargeable battery.

According to one embodiment, an organic acid salt is easily obtained by the wet method in which a lithium compound and a vanadium compound are mixed together with an organic acid and the mixture is fired.

Furthermore, since the molar ratio of lithium and vanadium included in the lithium compounds and the vanadium compounds that are mixed with the organic acid, is adjusted to between 1.2:1 and 1.24:1, it is possible to provide a non-aqueous rechargeable battery having a higher discharge capacity.

In another embodiment, since the organic acid is added in an excessive amount of between 1.5 to 5 times more than the molar weight required to react with the lithium compound and the vanadium compound, it is possible to provide a negative material that after firing, has a high discharge capacity.

According to another embodiment, the open circuit potential of the negative material has a desirable plateau. Since the plateau has an average potential for intercalating lithium ions ranging from between 0.20 to 0.25V and an average potential for deintercalating lithium ions ranging from between 0.23 to 0.27, it is possible to provide a flat potential that is near the potential of a negative material including graphite. Accordingly, the resulting non-aqueous rechargeable battery is endowed with high energy density by using lithium vanadium oxide that has a high capacity per volume, instead of using a conventional negative material including graphite.

Furthermore, it is possible to stabilize the potential and to improve the charge and discharge characteristics when the charge and discharge of the negative electrode are repeated since the plateau is formed over at least 25% of the abscissa, based on the entire reaction period after the first intercalation and deintercalation of lithium ions.

In addition, according to another embodiment, the potential is remarkably stabilized even though the charge and discharge are repeated; this stabilization is evidence from the plateau which is formed over 40% or more of the abscissa, based on the entire reaction period in the charge and discharge characteristics after the first intercalation and deintercalation.

Hereinafter, a non-aqueous rechargeable battery constructed as one embodiment of the present invention will be described referring to the attached drawings.

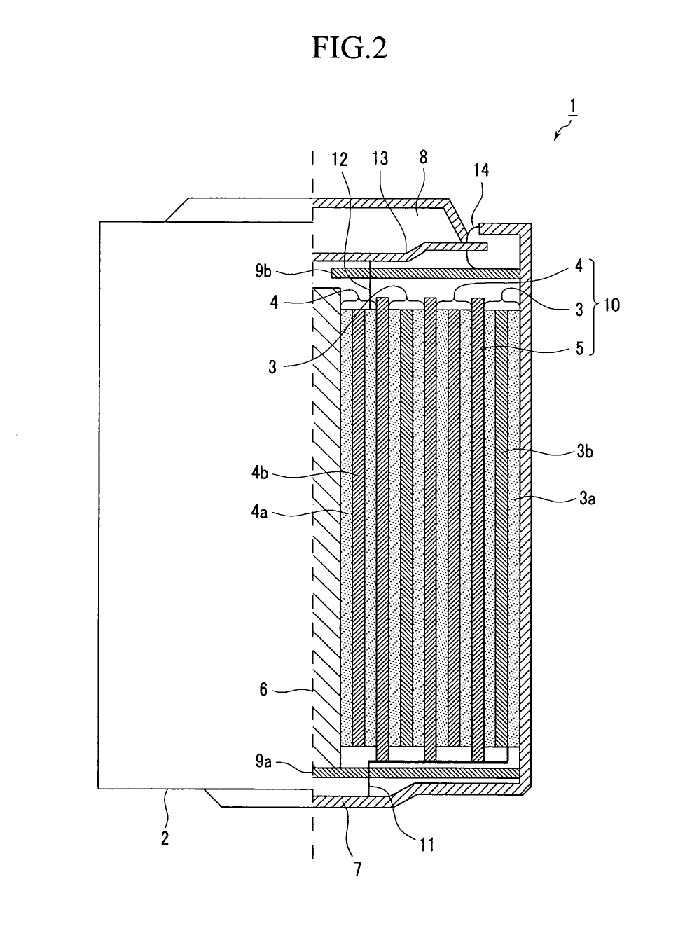

FIG. 2 is a vertical cross-sectional elevation view of a non-aqueous rechargeable battery constructed as one embodiment of the present invention. Non-aqueous rechargeable battery 1 is a spirally wound cylindrical battery. Non-aqueous rechargeable battery 1 includes center pin 6 and electrode assembly 10 wound around center pin 6. Herein, electrode assembly 10 includes positive electrode 3 and negative electrode 4, and separator 5 inserted between positive electrode 3 and negative electrode 4. Accordingly, electrode assembly 10 has a cylindrical structure.

Positive electrode 3 is formed by disposing positive active mass 3a including a positive active material on both surfaces of positive current collector 3b. Negative electrode 4 is formed by disposing negative active mass 4a including a negative active material on both surfaces of negative current collector 4b. Cylindrical electrode assembly 10 is housed in cylindrical case 2 with a hollow interior, and is impregnated with an electrolyte (not separately shown). Positive electrode 3 contacts case 2, and has positive terminal 7 that protrudes at the bottom of case 2.

Electrode assembly 10 is mounted with insulating plates 9b and 9a at the top and bottom thereof. Positive current collector 3b passes through insulating plate 9a and contacts positive terminal 7 by way of positive electrode lead 11. Safety plate 13 is mounted above insulating plate 9b located at the opened base end of case 2 in the same direction as insulating plate 9b. Negative terminal 8 is shaped as a convex cap and is mounted on safety plate 13 in the opposite direction to safety plate 13. Negative current collector 4b passes through insulating plate 9b and contacts negative terminal 8 by way of negative electrode lead 12. In addition, safety plate 13 and the edge of negative terminal 8 are sealed by an electrically insulating gasket 14, which separates safety plate 13 and negative terminal 8 from positive terminal 7.

The positive active material and the electrolyte may include a common positive electrode and electrolyte for a non-aqueous rechargeable battery. For example, the positive active material may include a lithium transition element oxide such as lithium cobalt oxide and the like. The electrolyte may include a solute including a lithium salt selected from the group consisting of LiPF₆, Li₂SiF₆, Li₂TiF₆, LiBF₄, and the like in a solvent such as ethylene carbonate, diethyl carbonate, or the like.

Negative electrode 4 includes the above material for a negative active material. Examples of the negative active material include lithium vanadium oxide represented by LiₐV_{b}M_{c}O_{d}. The representative element M is at least one element selected from the group consisting of transition elements, alkali metals, and alkaline earth metals, and the variables a, b, c, and d are arbitrary values. In addition, the negative electrode may be formed in the practice of the principles of this invention as follows: a negative material, a conductive agent such as acetylene black, and a binder are mixed to obtain a slurry, and then the slurry is coated onto a copper negative current collector 4b and pressed.

The lithium vanadium oxide is obtained by firing an organic acid salt precursor represented by LiₐV_{b}M_{c}O_{d}(C₂O₄) under an atmosphere such as nitrogen.

For example, the organic acid salt can be obtained by reacting a lithium compound such as lithium carbonate (Li₂CO₃), a vanadium compound such as vanadium pentaoxide (V₂O₅), and an organic acid such as oxalic acid ((COOH₂) in an aqueous solution and then drying by evaporation.

Furthermore, when lithium carbonate, vanadium pentaoxide, and oxalic acid are used, the cost can be particularly reduced and an organic acid salt can be obtained. The lithium compound may include lithium hydroxide or lithium oxalate. The organic acid may include acetic acid, citric acid, malic acid, or succinic acid other than oxalic acid.

According to the manufacturing method, the lithium vanadium oxide is obtained by firing an organic acid salt in which lithium atoms and vanadium atoms are preliminarily mixed. In comparison to the conventional lithium vanadium oxide obtained by mixing a lithium compound and a vanadium compound and firing it, in the practice of the present invention, lithium and vanadium atoms tend to be uniformly solid-solved at a micron level in the embodiment. Accordingly, it is possible to provide a lithium vanadium oxide having a uniform composition. The following examples illustrate the principles of the present invention in greater detail. It is to be understood however, that the present invention is not limited by these examples.

### EXAMPLE 1

### Preparation of Lithium Vanadium Oxide

A lithium compound of lithium carbonate Li₂CO₃, a vanadium compound of vanadium pentaoxide V₂O₅, and an organic acid of oxalic acid (COOH)₂ were mixed and reacted in an aqueous solution, then evaporated to provide an organic acid salt LiₐV_{b}M_{c}O_{d}C₂O₄. The molar ratio of lithium and vanadium of the lithium carbonate and vanadium pentaoxide was 1.22:1, and the organic acid was added in the amount of 1.5 times more than the molar ratio required for reacting with the lithium carbide and vanadium pentaoxide.

The obtained organic acid salt precursor was fired under a nitrogen atmosphere at 1100° C. to obtain lithium vanadium oxide.

### EXAMPLE 2

### Preparation of Lithium Vanadium Oxide

Lithium vanadium oxide was prepared in accordance with the same procedure as in Example 1, except that citric acid was used instead of oxalic acid.

### COMPARATIVE EXAMPLE 1

26.35 g of LiOH and 67.5 g of V₂O₃ were mixed according to a solid-phase method and fired at 650° C. to provide lithium vanadium oxide.

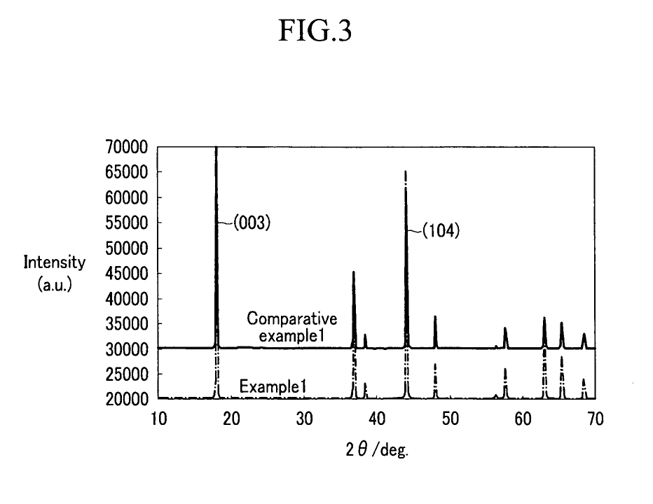

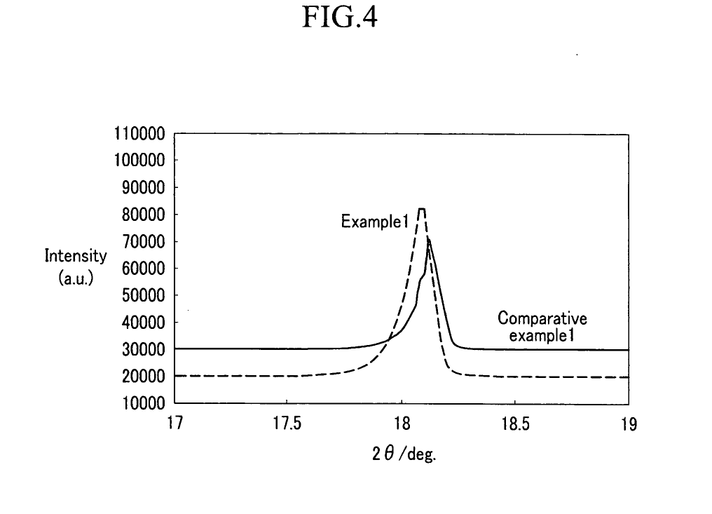

Lithium vanadium oxides prepared according to Example 1 and Comparative Example 1 were subjected to an X-ray diffraction analysis. The results are shown in FIGS. 3 and 4.

FIG. 3 shows a graph showing an X-ray diffraction analysis result of lithium vanadium oxides according to Example 1 and Comparative Example 1, and FIG. 4 is a partially enlarged view of the peak for the (003) plane shown in FIG. 3.

As shown in FIGS. 3 and 4, the peak intensity ratio of the (104) plane to the (003) plane of lithium vanadium oxide prepared according to Example 1, was 0.6, and on the other hand, the peak intensity ratio of the (104) plane to the (003) plane of lithium vanadium oxide prepared according to Comparative Example 1, was 0.3.

### EXAMPLE 3

### Manufacturing Lithium Rechargeable Cell

For Example 3, 80 wt % of lithium vanadium oxide prepared from Example 1, 10 wt % of acetylene black, and 10 wt % of polyvinylidene fluoride were mixed and then coated onto a negative electrode current collector including copper. Then, the coated negative electrode current collector was compressed by as much as 1.8 g/cm³ to provide a negative electrode.

91 wt % of a positive active material of LiCoO₂, 3 wt % of acetylene black, and 6 wt % of polyvinylidene fluoride were mixed to provide a positive electrode. Additionally, a solvent of a non-aqueous electrolyte solution included a mixed solvent of EC:DEC=3:7 (volume ratio), and the electrolyte included LiPF₆.

Then, the electrolyte solution was injected into the electrode assembly and the inlet was sealed after the cell stood for one hour to provide a lithium rechargeable cell.

### EXAMPLE 4

### Manufacturing Lithium Rechargeable Cell

A lithium rechargeable cell was manufactured in accordance with the same procedure as followed in Example 3, except that the lithium vanadium oxide prepared according to Example 2 was used.

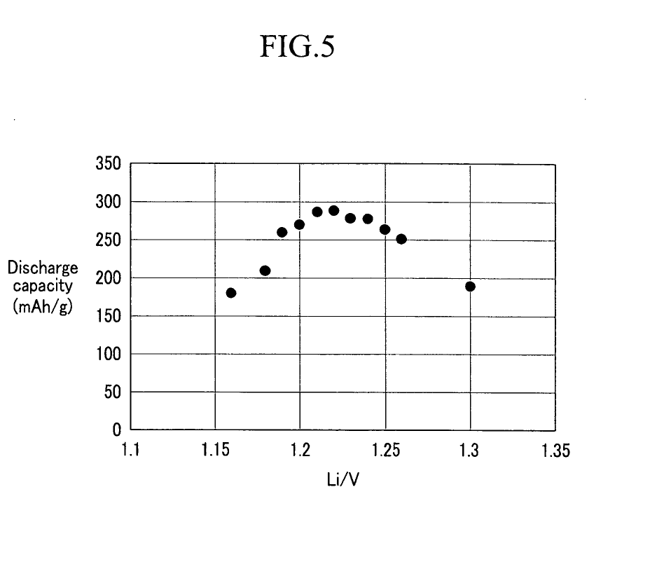

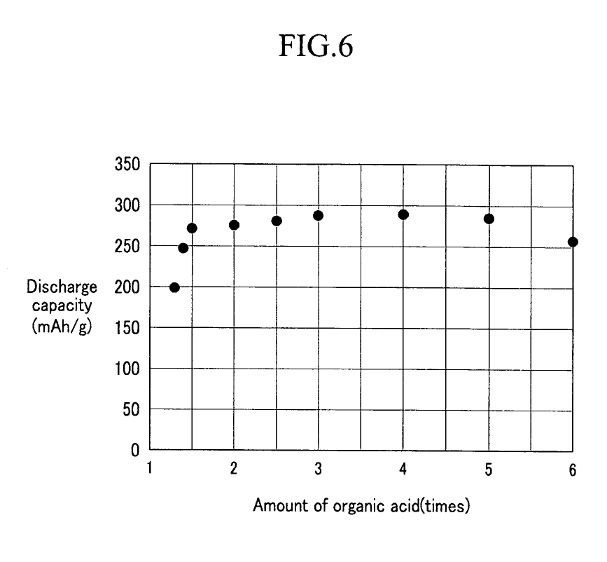

In Example 4, lithium vanadium oxide was prepared in accordance with the same procedure as in Example 1, except that the molar ratio of lithium and vanadium in Li₂CO₃ and V₂O₅ intercalated in (COOH)₂ was varied, or the amount of organic acid was which was added, was varied in different samples prepared for Example 4. Then, the lithium vanadium oxide was used for an electrode and the metallic lithium was used for a counter electrode to provide a test cell having a lithium standard open circuit potential. The cell was subjected to measurement of charge and discharge capacity, and these results are shown in FIGS. 5 and 6.

In FIG. 5 and FIG. 6, the ordinate, or vertical axis, refers to a discharge capacity (unit: mAh/g) of test cells. In FIG. 5, the abscissa, or horizontal axis, refers to a molar ratio of lithium and vanadium in Li₂CO₃ and V₂O₅ intercalated in (COOH)₂. The organic acid was added in a molar weight of 1.5 times more than the molar weight required for reacting with lithium carbonate and vanadium pentaoxide.

As shown in FIG. 5, when the molar ratio of lithium in Li₂CO₃ and vanadium in V₂O₅ was between 1.2:1 and 1.24:1, it is possible to increase the discharge capacity.

Additionally, the horizontal axis of FIG. 6 refers to the amount of (COOH)₂ existing in the reaction of Li₂CO₃, V₂O₅, and (COOH)₂ as a ratio when the used amount of (COOH)₂ was considered to be 1. In other words, the organic acid salt of LiₐV_{b}M_{c}O_{d}C₂O₄ is represented as Formula 1, and the amount of (COOH)₂ used in the reaction is X-Y moles. In FIG. 6, the abscissa, or horizontal axis, refers to the ratio of X/(X-Y). Furthermore, z is an arbitrary value.

1.22Li₂CO₃+V₂O₅+X(COOH)₂+zM→LiₐV_{b}M_{c}O_{d}C₂O₄+Y(COOH)₂ (2)

As shown in FIG. 6, it is possible to provide a high discharge capacity if (COOH)₂ exists in a molar weight of between 1.5 to 5 times more than the molar weight required for reacting with Li₂CO₃ and V₂O₅.

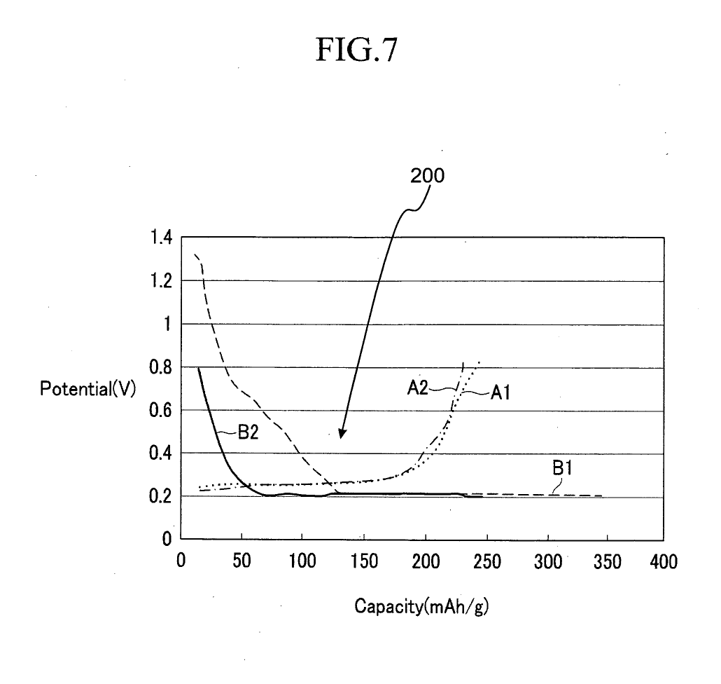

Lithium vanadium oxide for the negative material prepared according to Example 1 was measured for charge and discharge characteristics. The results are shown in FIG. 7.

The test cell included an electrode of metallic lithium and a counter electrode of lithium vanadium oxide according to Example 1, and it was measured for a lithium standard open circuit potential. The vertical axis refers to potential (unit: V), and the horizontal axis refers to capacity (unit: mAh/b). The molar ratio of lithium included in Li₂CO₃ and vanadium in V₂O₅ intercalated in (COOH)₂ was 1.22:1.

As shown in FIG. 7, A1 refers to the potential in the case of the first intercalation of lithium ions. B1 refers to the potential in the case of the first deintercalation of lithium ions. A2 refers to the potential in the case of the 10th intercalation of lithium ions and B2 refers to the potential in the case of 10th deintercalation of lithium ions.

As shown in FIG. 7, in the test cell including lithium vanadium oxide according to Example 1, the plateau 200 at which the potential was varied within 0.05V was formed over 70% or more based on the entire reaction period illustrated along the abscissa when lithium ions were intercalated into the negative electrode at 1st and 10th times A1 and A2 and deintercalated at 1st and 10th times B1 and B2. When lithium was intercalated, the plateau had a flat potential having an average potential of around 0.22V, and when lithium was deintercalated, the plateau had a flat potential having an average potential of around 0.25V.

As shown in FIG. 1, in the test cell using the conventional lithium vanadium oxide prepared by the solid phase method, a plateau was formed at the first intercalation A11 and deintercalation B11 of lithium ions. However, the plateau was not formed at the 10th intercalation A 12 and deintercalation B12 of lithium ions.

It is postulated that this result occurred because the lithium vanadium oxide had a uniform particle composition and a stable crystalline structure. Thereby, it is possible to provide a non-aqueous rechargeable cell 1 having a stable charge and discharge potential. Further, in the lithium vanadium oxide prepared by the solid-phase method, a plateau was not formed on the second intercalation and deintercalation of lithium ions.

When the greater ratio of lithium included in Li₂CO₃ and vanadium in V₂O₅ intercalated in (COOH)₂ of between 1.2:1 and 1.24:1 was present, the flat potential shown in FIG. 5 was shown. Within the range to achieve the high discharge capacity, the plateau had a flat potential ranging from 0.20 to 0.25V at the intercalation of lithium ions, and the plateau had a flat potential ranging from 0.23 to 0.27V at the deintercalation of lithium ions.

In the lithium vanadium oxide prepared according to one embodiment, the capacity 111 rapidly deteriorated when further cycles of charge and discharge were repeated. When the life-cycle deteriorated by 50% of the total capacity, the plateau which was formed extended over 25% based on the entire reaction period. When the plateau formed extends over 20% or more based on the entire reaction period, it did not cause substantial damage. When the plateau formed extended over 25% or more, the lithium oxide provided a substantially sufficient performance. When an plateau was formed that extended over 40% or more based on the entire reaction period, the lithium oxide was able to provide a remarkably stable non-aqueous, rechargeable battery.

According to one embodiment, lithium vanadium oxide included in negative electrode 4 was prepared by firing an organic acid salt including lithium and vanadium so that the firing was able to be performed uniformly, and the crystalline structure produced by the firing was stable. Thereby, the charge and discharge potential of non-aqueous rechargeable cell 1 became stable and capable of providing improved charge and discharge characteristics that extended over successive cycles of charge and discharge.

As the organic acid salt was obtained by mixing Li₂CO₃ and V₂O₅ with (COOH)₂, the organic acid salt LiₐV_{b}M_{c}O_{d}C₂O₄ was easily provided by the wet method. The source for lithium may include another lithium compound, and the source for vanadium may include another vanadium compound. Moreover, the mixture may include an organic acid other than (COOH)₂.

According to contemporary methods, since the lithium vanadium oxide included trivalent or quadric-valent vanadium, expensive V₂O₃ or V₂O₄ was required as a source for vanadium. According to the practice of one embodiment of the present invention, V₂O₅ including 5-valent vanadium is reduced into trivalent or quadric-valent vanadium in the wet method. Accordingly, the cost will be reduced in preparing the negative material or when constructing a non-aqueous rechargeable battery including that negative material because the inexpensive V₂O₅ replaces the expensive sources (e.g., V₂O₃ or V₂O₄) of vanadium oxide.

Since the charge and discharge characteristics of the negative material exhibited a plateau, the plateau had an average potential ranging from between 0.20 to 0.25V on intercalating lithium ions, and the plateau had an average potential ranging from between 0.23 to 0.27V on deintercalating lithium ions; consequently, a flat potential was formed that was near to that of contemporary negative material which includes graphite. Accordingly, it is possible to provide a non-aqueous rechargeable battery having high energy density by using lithium vanadium oxide which has a high capacity per volume, instead of the contemporary negative material.

While this invention has been described in connection with what is presently considered to be practical exemplary embodiments, it is to be understood that the invention is not limited to the disclosed embodiments but, on the contrary, is intended to cover various modifications and equivalent arrangements included within the spirit and scope of the appended claims.

What is claimed is:

1. A negative material for a non-aqueous rechargeable battery comprising lithium vanadium oxide:
wherein the lithium vanadium oxide has an open circuit potential having a plateau over 25% or more based on the entire reaction period of the intercalation or deintercalation of lithium ions;
wherein the plateau is varied within 0.05V when the lithium electrode is charged and discharged; and
wherein the plateau has an average potential of intercalation of lithium ions ranging from 0.20 to 0.25 V and an average potential of deintercalation of lithium ions ranging from 0.23 to 0.27 V.

2. The negative material for a non-aqueous rechargeable battery of claim 1, wherein the plateau is formed over 25% or more based on the entire reaction period in the charge and discharge characteristics after the first intercalation and deintercalation of lithium ions.

3. A negative material for a non-aqueous rechargeable battery of claim 1, wherein the plateau is formed over 40% or more based on the entire reaction period in the charge and discharge characteristics after the first intercalation and deintercalation of lithium ions.

4. A negative material for a non-aqueous rechargeable battery of claim 1:
wherein the lithium vanadium oxide has an open circuit potential having a plateau over 25% or more based on the entire reaction period of the intercalation or deintercalation of lithium ions;
wherein the plateau is varied within 0.05V when the lithium electrode is charged and discharged;
wherein the plateau has an average potential of intercalation of lithium ions ranging from 0.20 to 0.25 V and an average potential of deintercalation of lithium ions ranging from 0.23 to 0.27 V; and
wherein the plateau is formed over 25% or more based on the entire reaction period of the charge and discharge characteristics after the lithium ions are intercalated and deintercalated the first time.

5. The negative material for a non-aqueous rechargeable battery of claim 1, wherein the lithium vanadium oxide is obtained by firing an organic acid salt comprising lithium and vanadium.

6. The negative material for a non-aqueous rechargeable battery of claim 5, wherein the organic acid salt is obtained by mixing a lithium compound and a vanadium compound with an organic acid.

7. The negative material for a non-aqueous rechargeable battery of claim 6, wherein the molar ratio of lithium and vanadium included in the lithium compound and the vanadium compound that are mixed with the organic acid ranges from 1.2:1 to 1.24:1.

8. The negative material for a non-aqueous rechargeable battery of claim 7, wherein the organic acid is added in a molar weight of 1.5 to 5 times more than the molar weight required for reacting with the lithium compound and the vanadium compound.

9. The negative material for a non-aqueous rechargeable battery of claim 1, wherein the negative material has a peak intensity ratio of the (104) plane to the (003) plane ranging from 0.2 to 0.8.

10. A non-aqueous rechargeable battery, comprising:
a negative electrode;
a positive electrode; and
an electrolyte;
wherein the negative electrode comprises a lithium vanadium oxide having an open circuit potential having a plateau over 25% or more based on the entire reaction period of the intercalation or deintercalation of lithium ions;
wherein the plateau is varied within 0.05V when the lithium electrode is charged and discharged; and
wherein the plateau has an average potential of intercalation of lithium ions ranging from 0.20 to 0.25 V and an average potential of deintercalation of lithium ions ranging from 0.23 to 0.27 V.

11. The non-aqueous rechargeable battery of claim 10, wherein the plateau is formed over 25% or more based on the entire reaction period of the charge and discharge characteristics after the lithium ions are intercalated and deintercalated the first time.

12. The non-aqueous rechargeable battery of claim 10, wherein the plateau is formed over 40% or more based on the entire reaction period of the charge and discharge characteristics after the lithium ions are intercalated and deintercalated the first time.

13. A non-aqueous rechargeable battery of claim 10:
wherein the lithium vanadium oxide has an open circuit potential having a plateau over 25% or more based on the entire reaction period of the intercalation or deintercalation of lithium ions;
wherein the plateau is varied within 0.05V when the lithium electrode is charged and discharged;
wherein the plateau has an average potential of intercalation of lithium ions ranging from 0.20 to 0.25 V and an average potential of deintercalation of lithium ions ranging from 0.23 to 0.27 V; and
wherein the plateau is formed over 25% or more based on the entire reaction period of the charge and discharge characteristics after the lithium ions are intercalated and deintercalated the first time.

14. The non-aqueous rechargeable battery of claim 10, wherein the lithium vanadium oxide is obtained by firing an organic acid salt including lithium and vanadium.

15. The non-aqueous rechargeable battery of claim 14, wherein the organic acid salt is obtained by mixing a lithium compound and a vanadium compound with an organic acid.

16. The non-aqueous rechargeable battery of claim 15, wherein the molar ratio of lithium and vanadium included in the lithium compound and the vanadium compound mixed with the organic acid ranges from 1.2:1 to 1.24:1.

17. The non-aqueous rechargeable battery of claim 15, wherein the organic acid is added at 1.5 to 5 times more than the molar weight required for reacting with the lithium compound and the vanadium compound.

18. The non-aqueous rechargeable battery of claim 10, wherein the negative material has a peak intensity ratio of the (104) plane to the (003) plane ranging from 0.2 to 0.8.
